(19) United States
(12) Patent Application Publication
(10) Pub. No.: US 2022/0292707 A1
(43) Pub. Date: Sep. 15, 2022

(54) ESTIMATION DEVICE, LEARNING DEVICE, CONTROL METHOD AND STORAGE MEDIUM

(71) Applicant: NEC Corporation, Minato-ku, Tokyo (JP)

(72) Inventor: Yasunori BABAZAKI, Tokyo (JP)

(73) Assignee: NEC Corporation, Minato-ku, Tokyo (JP)

(21) Appl. No.: 17/633,277

(22) PCT Filed: Aug. 22, 2019
(86) PCT No.: PCT/JP2019/032842

§ 371 Date: Feb. 7, 2022

(51) Int. Cl. G06T 7/70; G06N 20/00

(52) U.S. Cl. CPC G06T 7/70; G06N 20/00; G06T 2207/20081

(57) ABSTRACT

An estimation device 30A includes a feature map generation unit 51A, an attention area map generation unit 52A, a map integration unit 53A, and a feature point information generation unit 54A. The feature map generation unit 51A is configured to generate a feature map Mf, which is a map of feature quantities relating to a feature point subjected to extraction, from an input image. The attention area map generation unit 52A is configured to generate an attention area map Mi, which is a map representing a degree of importance in the position estimation of the feature point, from the feature map Mf. The map integration unit 53A is configured to generate an integrated map Mfi in which the feature map Mf and the attention area map Mi are integrated. The feature point information generation unit 54A is configured to generate feature point information Ifp, which is information relating to an estimate position of the feature point, based on the integrated map Mfi.

### TECHNICAL FIELD

The present invention relates to a technical field of an estimation device, a learning device, a control method, and a storage medium for machine learning and estimation based on the machine learning.

### BACKGROUND ART

An example of a method of extracting predetermined feature points from an image is disclosed in Patent Literature 1. Patent Literature 1 discloses a method of extracting a feature point serving as a corner or intersection for each local region in the input image by use of a known feature point extractor such as a corner detector.

### PRIOR ART DOCUMENTS

### Patent Literature

Patent Literature 1: JP 2014-228893A

### SUMMARY

### Problem to be Solved by the Invention

In the method of Patent Literature 1, the type of extractable feature points is limited and therefore it is impossible to accurately acquire information on any feature points, which are specified in advance, from a given image.

In view of the above-described issue, it is therefore an example object of the present disclosure to provide an estimation device, a learning device, a control method, and a storage medium capable of obtaining information regarding a specified feature point from an image with a high degree of accuracy.

### Means for Solving the Problem

In one mode of the estimation device, there is provided an estimation device including: a feature map generation unit configured to generate a feature map, which is a map of feature quantities relating to a feature point subjected to extraction, from an input image; an attention area map generation unit configured to generate an attention area map, which is a map representing a degree of importance in position estimation of the feature point, from the feature map; a map integration unit configured to generate an integrated map in which the feature map and the attention area map are integrated; and a feature point information generation unit configured to generate feature point information, which is information relating to an estimate position of the feature point, based on the integrated map.

In one mode of the learning device, there is provided a learning device including: an attention area map generation unit configured to generate an attention area map, which is a map representing a degree of importance in position estimation of a feature point subjected to extraction, from a feature map that is a map of feature quantities relating to the feature point, the feature map being generated based on an input image; a feature point information generation unit configured to generate feature point information, which is information relating to an estimate position of the feature point, based on an integrated map in which the feature point map and the attention area map are integrated; and a training unit configured to perform training of the attention area map generation unit and the feature point information generation unit based on the feature point information and correct answer information regarding a correct answer position of the feature point.

In one mode of the control method, there is provided a control method performed by an estimation device, the control method including: generating a feature map, which is a map of feature quantities relating to a feature point subjected to extraction, from an input image; generating an attention area map, which is a map representing a degree of importance in position estimation of the feature point, from the feature map; generating an integrated map in which the feature map and the attention area map are integrated; and generating feature point information, which is information relating to an estimate position of the feature point, based on the integrated map.

In another mode of the control method, there is provided a control method performed by a learning device, the control method including: generating an attention area map, which is a map representing a degree of importance in position estimation of a feature point subjected to extraction, from a feature map that is a map of feature quantities relating to the feature point, the feature map being generated based on an input image; generating feature point information, which is information relating to an estimate position of the feature point, based on an integrated map in which the feature point map and the attention area map are integrated; and performing training of a process of generating the attention area map and a process of generating the feature point information, based on the feature point information and correct answer information regarding a correct answer position of the feature point.

In one mode of the storage medium, there is provided a storage medium storing a program executed by a computer, the program causing the computer to function as: a feature map generation unit configured to generate a feature map, which is a map of feature quantities relating to a feature point subjected to extraction, from an input image; an attention area map generation unit configured to generate an attention area map, which is a map representing a degree of importance in position estimation of the feature point, from the feature map; a map integration unit configured to generate an integrated map in which the feature map and the attention area map are integrated; and a feature point information generation unit configured to generate feature point information, which is information relating to an estimate position of the feature point, based on the integrated map.

In another mode of the storage medium, there is provided a storage medium storing a program executed by a computer, the program causing the computer to function as: an attention area map generation unit configured to generate an attention area map, which is a map representing a degree of importance in position estimation of a feature point subjected to extraction, from a feature map that is a map of feature quantities relating to the feature point, the feature map being generated based on an input image; a feature point information generation unit configured to generate feature point information, which is information relating to an estimate position of the feature point, based on an integrated map in which the feature point map and the attention area map are integrated; and a training unit configured to perform training of the attention area map generation unit and the feature point information generation unit based on the feature point information and correct answer information regarding a correct answer position of the feature point.

### Effect of the Invention

An example advantage according to the present invention is to suitably obtain information regarding specified feature points from an image with a high degree of accuracy. Besides, it is possible to perform the learning so as to obtain information regarding specified feature points from an image with a high degree of accuracy.

### BRIEF DESCRIPTION OF THE DRAWINGS

FIG. 1 illustrates a schematic configuration of an information processing system according to a first example embodiment.

FIG. 2 is a functional block diagram of a learning device according to a first training.

FIG. 3A illustrates a first example of an attention area map.

FIG. 3B illustrates a second example of the attention area map.

FIG. 4A illustrates a third example of the attention area map.

FIG. 4B illustrates a fourth example of the attention area map.

FIG. 5A illustrates, in a case where the head of an aquaculture fish is a feature point subjected to extraction, the attention area map which is outputted by a learned attention area output machine and which is superimposed on a first training image.

FIG. 5B illustrates, in a case where the belly of an aquaculture fish is a feature point subjected to extraction, the attention area map which is outputted by a learned attention area output machine and which is superimposed on a first training image.

FIG. 6 illustrates a functional block diagram of a learning device according to a second training.

FIG. 7 illustrates an outline of the second training using a second training image of an aquaculture fish.

FIG. 8 is a flowchart showing the processing procedure of the first training.

FIG. 9 is a flowchart showing the processing procedure of the second training.

FIG. 10 is a functional block diagram of an estimation device.

FIG. 11 is a flowchart showing the procedure of the estimation process.

FIG. 12A illustrates, on an input image obtained by photographing a tennis coat, an estimate position corresponding to the coordinate value of the feature point estimated by the estimation device.

FIG. 12B illustrates, on an input image obtained by photographing a person, an estimate position of the feature point estimated by the estimation device.

FIG. 13 is a block diagram of a learning device according to a second example embodiment.

FIG. 14 is a block diagram of an estimation device according to the second example embodiment.

### EXAMPLE EMBODIMENTS

Hereinafter, example embodiments of an estimation device, a learning device, a control method, and a storage medium will be described with reference to the drawings.

### First Example Embodiment

### (1) Overall Configuration

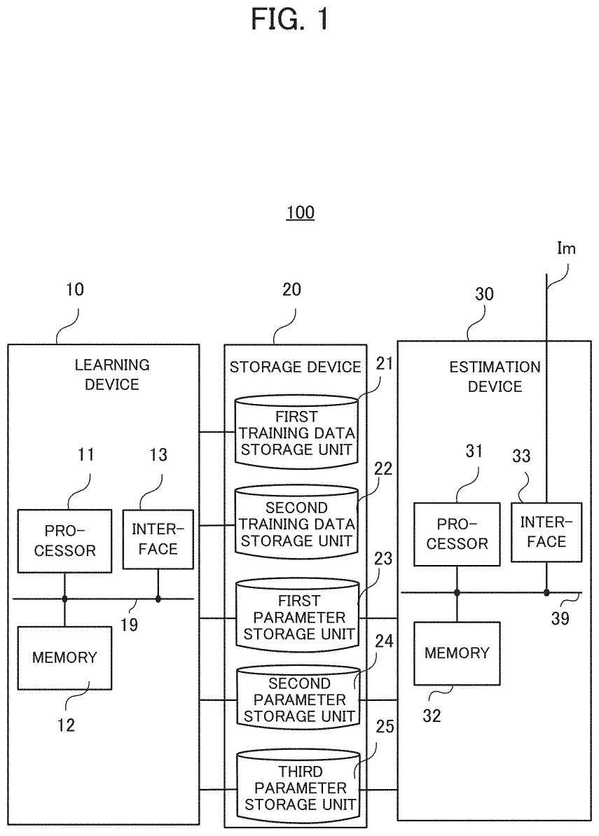

FIG. 1 shows a schematic configuration of an information processing system 100 according to the first example embodiment. The information processing system 100 performs processing related to the extraction of feature points on an image using a learning model.

The information processing system 100 includes a learning device 10, a storage device 20, and an estimation device 30.

The learning device 10 learns a plurality of learning models to be used for extracting feature points in the image based on training data stored in the first training data storage unit 21 and the second training data storage unit 22.

The storage device 20 is a device which the learning device 10 and the estimation device 30 can refer to and write data on, and includes a first training data storage unit 21, a second training data storage unit 22, a first parameter storage unit 23, a second parameter storage unit 24, and a third parameter storage unit 25.

The storage device 20 may be an external storage device such as a hard disk connected to or built in to either the learning device 10 or the estimation device 30, or may be a storage medium such as a flash memory. For example, when the storage device 20 is a storage medium, information to be stored in the first parameter storage unit 23, the second parameter storage unit 24, and the third parameter storage unit 25 are stored in the storage medium after the generation thereof by the learning device 10, and then the estimation device 30 executes the estimation processing by reading the information from the storage medium. In addition, the storage device 20 may be a server device (i.e., a device that stores information in a state where the information can be referred to from another device) that performs data communication with the learning device 10 and the estimation device 30. In this case, the storage device 20 may include a plurality of server devices, and store the first training data storage unit 21, the second training data storage unit 22, the first parameter storage unit 23, the second parameter storage unit 24, and the third parameter storage unit 25 in a distributed manner.

The first training data storage unit 21 stores a plurality of combinations of an image (also referred to as a “training image”) to be used for training of the learning model and correct answer information regarding feature points to be extracted in the training image. Here, the correct answer information includes information indicating the coordinate value (correct answer coordinate value) of a feature point in the image to be the correct answer, and identification information indicative of the feature point. For example, when a nose that is a feature point is displayed in a training image, the correct answer information associated with the training image includes information indicating the correct answer coordinate value of the nose in the training image and identification information indicative of a nose. It is noted that the correct answer information may include information on a reliability map for the feature point to be extracted, instead of the correct coordinate value. The reliability map is defined, for example, to form a normal distribution of the reliability in the two dimensions, wherein the reliability at the correct answer coordinate value of each feature point is the maximum value of the distribution. Hereinafter, the “coordinate value” may be a value that specifies the position of a specific pixel in the image, or may be a value that specifies the position in the image in sub-pixel units.

The second training data storage unit 22 stores a plurality of combinations of a training image and correct answer information regarding the presence or absence of each feature point to be extracted on the training image. The training image stored in the second training data storage unit 22 may be an image in which processing such as trimming is performed on the training image stored in the first training data storage unit 21 on the basis of the feature point subjected to extraction. For example, a training image including the feature point subjected to extraction and a training image not including the feature point subjected to the extraction are generated, respectively, by setting the trimming position to a position moved by the direction and the distance randomly determined from the feature point subjected to the extraction. The second training data storage unit 22 stores such a training image generated in the above-mentioned way in association with correct answer information regarding the presence or absence of the feature point in the training image.

Hereinafter, the training image stored in the first training data storage unit 21 is referred to as the “first training image Ds1”, and the correct answer information stored in the first training data storage unit 21 is referred to as the “first correct answer information Dc1”. Further, the training image stored in the second training data storage unit 22 is referred to as the “second training image Ds2”, and the correct answer information stored in the second training data storage unit 22 is referred to as the “second correct answer information Dc2”.

The first parameter storage unit 23, the second parameter storage unit 24, and the third parameter storage unit 25 each includes parameters obtained through the training of the learning model. Such a learning model may be a learning model based on a neural network, or other types of the learning model such as a support vector machine, and may be a combination thereof. For example, if the learning model is a neural network such as a convolutional neural network, the parameters described above include the layer structure, the neuron structure of each layer, the number of filters and filter sizes in each layer, and the weights of each element of each filter. Before execution of the training, initial values of the parameters to be applied to each learning model are stored in the first parameter storage unit 23, the second parameter storage unit 24, and the third parameter storage unit 25, and the above-described parameters are updated every time the training is performed by the learning device 10. For example, the first parameter storage unit 23, the second parameter storage unit 24, and the third parameter storage unit 25 store the parameters for each type of the feature point to be extracted.

When an input image “Im” is inputted from an external device, the estimation device 30 generates information regarding the feature points subjected to extraction by using output (estimation) machines configured respectively by referring to the first parameter storage unit 2, the second parameter storage unit 24, and the third parameter storage unit 25. The external device for inputting the input image Im may be a camera for generating the input image Im, or may be a device which stores the generated input image Im.

### (2) Hardware Configuration

FIG. 1 also shows the hardware configuration of the learning device 10 and the estimation device 30. Here, the hardware configuration of the learning device 10 and the estimation device 30 will be described with continued reference to FIG. 1.

The learning device 10 includes, as hardware, a processor 11, a memory 12, and an interface 13. The processor 11, the memory 12, and the interface 13 are connected via a data bus 19.

The processor 11 executes a program stored in the memory 12 to execute processing related to learning of learning models. The processor 11 is a processor such as a CPU (Central Processing Unit) or a GPU (Graphics Processing Unit).

The memory 12 is configured by various memories such as a RAM (Random Access Memory), a ROM (Read Only Memory), and a flash memory. In addition, a program executed by the processor 11 is stored in the memory 12. The memory 12 is used as a work memory and temporarily stores information acquired from the storage device 20. The memory 12 may function as a part of the storage device 20 or the storage device 20. In this case, the memory 12 may store at least one of the first training data storage unit 21, the second training data storage unit 22, the first parameter storage unit 23, the second parameter storage unit 24, and the third parameter storage unit 25. The program executed by the processor 11 may be stored in any storage medium other than the memory 12.

The interface 13 is a communication interface for wired or wireless transmission and reception of data to and from the storage device 20 under the control of the processor 11, and includes a network adapter and the like. The learning device 10 and the storage device 20 may be connected by a cable or the like. In this case, the interface 13 may be a communication interface or performing data communication with the storage device 20 or may be an interface which conforms to a USB, a SATA (Serial AT Attachment), and the like for exchanging data with the storage device 20.

The estimator 30 includes, as hardware, a processor 31, a memory 32, and an interface 33.

The processor 31 executes a program stored in the memory 32, and executes extraction processing of predetermined feature points for the input image Im. The processor 31 is a processor such as a CPU, GPU, or the like.

The memory 32 is configured by various memories such as a RAM, a ROM, and a flash memory. In addition, a program executed by the processor 31 is stored in the memory 32. The memory 32 is used as a work memory and temporarily stores information acquired from the storage device 20. The memory 32 temporarily stores an input image Im to be inputted to the interface 33. The memory 32 may function as a part of the storage device 20 or the storage device 20. In this case, for example, the memory 32 may store at least one of the first parameter storage unit 23, the second parameter storage unit 24, and the third parameter storage unit 25. The program executed by the processor 31 may be stored in any storage medium other than the memory 32.

The interface 33 is an interface for wired or wireless data communication with the storage device 20 or the device that supplies the input image Im under the control of the processor 31, and examples thereof include a network adapter, a USB, a SATA, and the like. The interface for connecting to the storage device 20 and the interface for receiving the input image Im may be different. The interface 33 may also include an interface for sending processing results performed by processor 31 to an external device.

The hardware configuration of the learning device 10 and the estimation device 30 is not limited to the configuration shown in FIG. 1. For example, the learning device 10 may further include an input unit for receiving a user input, an output unit such as a display and a speaker, and the like. Similarly, the estimation device 30 may further include an input unit for receiving a user input, an output unit such as a display and a speaker, and the like.

### (3) Learning Processing

Next, details of the learning process executed by the learning device 10 will be described. The learning device 10 performs a first training using the training data stored in the first training data storage unit 21 and second training using the training data stored in the second training data storage unit 22, respectively.

### (3-1) Functional Configuration of First Training

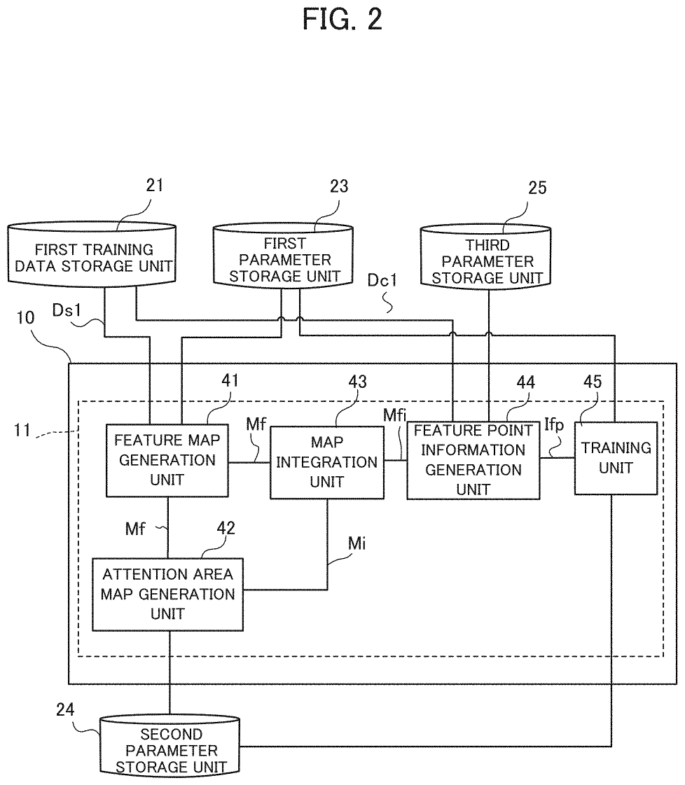

In the first training, by using the training data stored in the first training data storage unit 21, the learning device 10 collectively executes the training of each learning model to be used by the estimation device 20. FIG. 2 is a functional block diagram of the learning device 10 according to the first training using the training data stored in the first training data storage unit 21. As shown in FIG. 2, the processor 11 of the learning device 10 functionally includes a feature map generation unit 41, an attention area map generation unit 42, a map integration unit 43, a feature point information generation unit 44, and a training unit 45 in the first training.

The feature map generation unit 41 acquires a first training image “Ds1” from the first training data storage unit 21 and converts the acquired first training image Ds1 into a feature map “Mf” which is a map of feature quantities for extracting feature points. The feature map Mf may be two-dimensional data in the vertical and horizontal directions, or may be three-dimensional data including the channel direction. In this case, the feature map generation unit 41 configures a feature map output machine by applying the parameters stored in the first parameter storage unit 23 to the learning model configured to output the feature map Mf from an input image. The feature map generation unit 41 supplies the feature map Mf obtained by inputting the first training image Ds1 to the feature map output machine to the attention area map generation unit 42 and the map integration unit 43, respectively.

The attention area map generation unit 42 converts the feature map Mf supplied from the feature map generation unit 41 into a map (also referred to as “attention area map Mi”) representing a degree (i.e., degree of importance) to be paid attention to in the position estimation of the feature point. The attention area map Mi is a map having the same data length (number of elements) as the feature map Mf in the vertical and horizontal directions of the image, and will be described in detail later. In this case, the attention area map generation unit 42 configures an attention area map output machine by applying the parameters stored in the second parameter storage unit 24 to the learning model configured to output the attention area map Mi from the inputted feature map Mf. The attention area map output machine is configured for each type of feature point to be extracted. The attention area map generation unit 42 supplies the attention area map Mi obtained by inputting the feature map Mf to the attention area map output machine to the map integration unit 43.

The map integration unit 43 generates a map (also referred to as “integrated map Mfi”) in which the feature map Mf supplied from the feature map generation unit 41 and the attention area map Mi generated by the attention area map generation unit 42 are integrated. In this case, for example, the map integration unit 43 generates the integrated map Mfi in which the feature map Mf is multiplied by or added to the attention area map Mi on element-by-element basis at the same position, wherein the feature map Mf and the attention area map Mi are the same data lengths in the vertical and horizontal directions,. In another example, the map integration unit 43 may generate the integrated map Mfi by combining (i.e., generating a new channel data of the feature map Mf representing the weight) the feature map Mf with the attention area map Mi in the channel direction. The map integration unit 43 supplies the generated integrated map Mfi to the feature point information generation unit 44.

The feature point information generation unit 44 generates information (also referred to as “feature point information Ifp”) on the position of the feature point to be extracted, based on the integrated map Mfi supplied from the map integration unit 43. In this case, the attention area map generation unit 42 configures a feature point information output machine by applying the parameters stored in the third parameter storage unit 25 to the learning model configured to output the feature point information Ifp from the inputted integrated map Mfi. The learning model to be used in this case may be a learning model which calculates the coordinate value of the feature point to be extracted by direct regression, or may be a learning model which outputs a reliability map indicating the likelihood (reliability) of the position of the feature point to be extracted. The feature point information Ifp includes, for example, identification information relating to the type of the feature point extracted from the first training image Ds1, and a reliability map or a coordinate value of the feature point in the first training image Ds1. The feature point information output machine is configured for each type of the feature point to be extracted, for example. The feature point information generation unit 44 supplies the feature point information Ifp obtained by inputting the integrated map Mfi to the feature point information output machine to the training unit 45.

The training unit 45 acquires, from the first training data storage unit 21, the first correct answer information Dc1 corresponding to the first training image Ds1 acquired by the feature map generation unit 41. Then, the training unit 45 performs training of the feature map generation unit 41, the attention area map generation unit 42, and the feature point information generation unit 44 based on the acquired first correct answer information Dc1 and the feature point information Ifp supplied from the feature point information generation unit 44. In this case, the training unit 45 updates the respective parameters used by the feature map generation unit 41, the attention area map generation unit 42, and the feature point information generation unit 44 based on an error (loss) between the coordinate value or the reliability map of the feature point indicated by the feature point information Ifp and the coordinate value or the reliability map of the feature point indicated by the first correct answer information Dc1. In this case, the training unit 45 determines the above-described parameters so as to minimize the above-described loss. The loss in this case may be calculated using any loss function to be used in machine learning such as cross-entropy, mean square error and the like. The algorithm for determining the above-described parameters to minimize loss may also be any learning algorithm used in machine learning, such as a gradient descent method and an error back-propagation method. The training unit 45 stores the determined parameters of the feature map generation unit 41 in the first parameter storing unit 23, stores the determined parameters of the attention area map generation unit 42 in the second parameter storing unit 24, and stores the determined parameters of the feature point information generation unit 44 in the third parameter storing unit 25.

In the first training, by simultaneously performing the training of the attention area map generation unit 42 with the feature point information generation unit 44, the training unit 45 can suitably train the attention area map generation unit 42 so as to output the attention area map Mi with improved extraction accuracy of the feature point.

### (3-2) Example of Attention Area Map

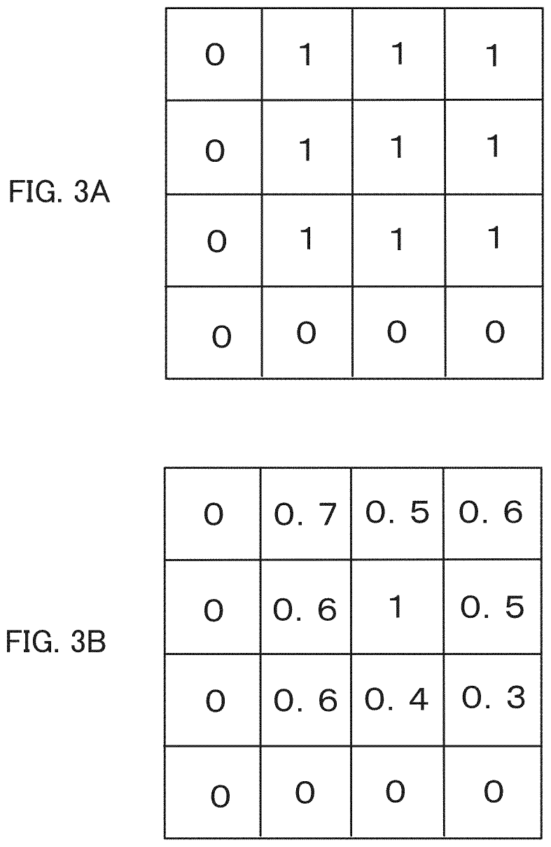

FIG. 3A shows a first example of the attention area map Mi. In the example of FIG. 3A, the value of each element of the attention area map Mi is represented by a binary number 0 or 1. The attention area map Mi has the same vertical and horizontal data lengths as the feature map Mf. When a convolutional neural network or the like is applied, generally, the vertical and horizontal data lengths of the attention area map Mi become smaller than the first training image Ds1 before the transformation to the attention area map Mi.

In this case, the values of the elements corresponding to the positions in the first training image Ds1 to be focused at the time of specifying the target feature point of extraction are set to “1”, and the values of the other elements are set to “0”. When such an attention area map Mi is used, the map integration unit 43 can suitably generate the integrated map Mfi that is the feature map Mf weighted so as to consider elements corresponding to positions on the image to be paid attention to when specifying the target feature point of the extraction.

FIG. 3B shows a second example of an attention area map Mi. In the example of FIG. 3B, the value of each element of the attention area map Mi is expressed by a real number from 0 to 1. In this case, the value of each element in the attention area map Mi is determined so that the higher the degree of attention to be paid to the position in the first training image Ds1 at the time of specifying the target feature point of extraction is, the closer the value of the corresponding element is to 1. Then, the elements in the attention area map Mi corresponding to the positions in the image that do not contribute to specifying the target feature point of the extraction is set to 0. Even when such an attention area map Mi is used, the map integration unit 43 can suitably generate the integrated map Mfi that is the feature map Mf in which the elements corresponding to the positions in the image to be paid attention to at the time of specifying the target feature point of the extraction are weighted with high weights.

Further, the attention area map generation unit 42 may add a positive constant to each element in the binary representation shown in FIG. 3A or in the real number representation shown in FIG. 3B so that an element to be “0” does not occur in the attention area map Mi.

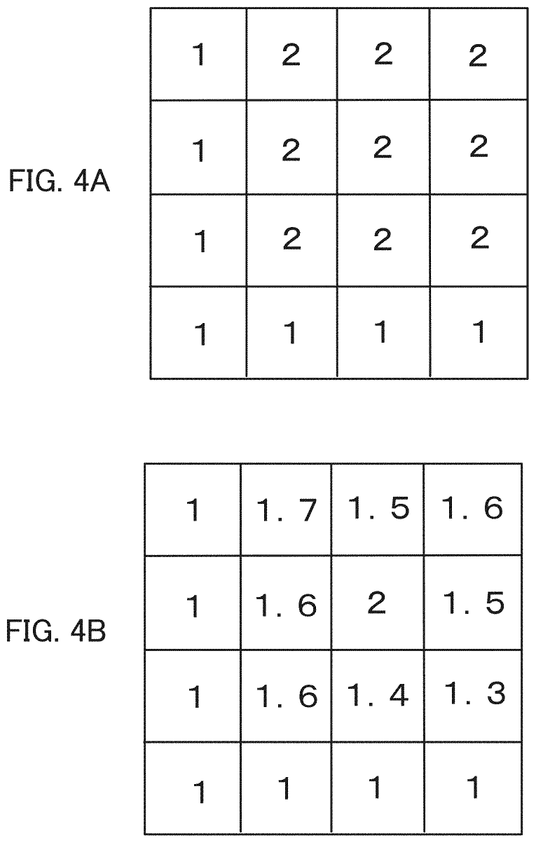

FIG. 4A shows a third example of the attention area map Mi, and FIG. 4B shows a fourth example of the attention area map Mi. FIGS. 4A and 4B show attention area maps Mi obtained by adding 1 to each element of the attention area maps Mi shown in FIGS. 3A and 3B. In the example of FIGS. 4A and 4B, the minimum value of the elements is “1”, the maximum value of the elements is “2”. In this case, even when each element of the feature map Mf and the attention area map Mi is multiplied by each other in the integration processing of the feature map Mf and the attention area map Mi, none of the elements of the integrated map Mfi becomes “0”. Therefore, in this case, the feature point information generation unit 44 can generate feature point information for the target feature point of the extraction by suitably considering the all elements of the feature map Mf corresponding to the entire area in the first training image Ds1.

Further, the learning (training) of the attention area map output machine used by the attention area map generation unit 42 is performed for each type of the feature point to be extracted (for each object and for each portion in the same object). Therefore, the attention area map Mi outputted by the attention area map output machine differs in the size of the attention area depending on the type of the feature point.

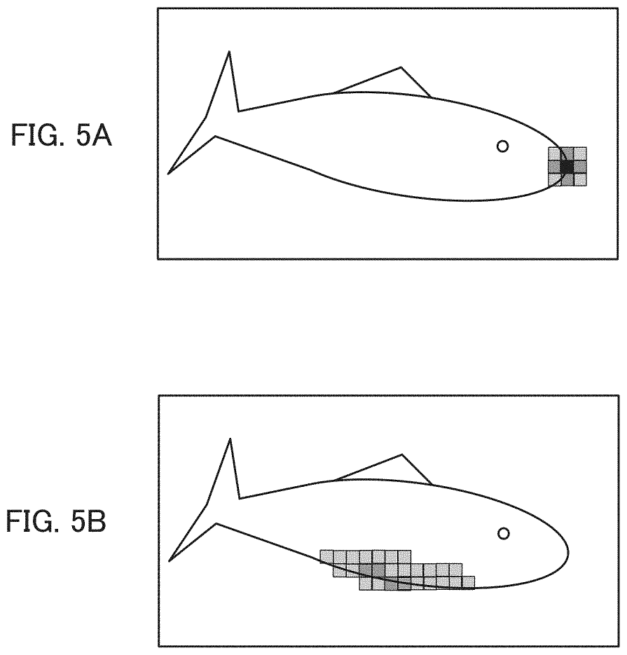

FIG. 5A is a diagram in which an attention area map Mi outputted by the learned attention area output machine is superimposed on the first training image Ds1 in a case where the head of the aquaculture fish is set as a feature point to be extracted. FIG. 5B is a diagram in which an attention area map Mi outputted by the learned attention area output machine is superimposed on the first training image Ds1 in a case where the belly of the aquaculture fish is set as a feature point to be extracted. In FIGS. 5A and 5B, as an example, elements of the attention area map Mi are assumed to have real values from “0” to “1” (see FIG. 3B). Then, in FIGS. 5A and 5B, an area (that is an area to be paid attention to in the generation of feature point information by the feature point information generation unit 44 and hereinafter also referred to as “attention area”) configured by elements of the attention area map Mi larger than a predetermined value (e.g., 0) is hatched, and the higher the real value is, the denser it is displayed.

As shown in FIG. 5A, when the head of the aquaculture fish is the target feature point of the extraction, the elements of the attention area map Mi that are real values larger than a predetermined value are concentrated near the head of the aquaculture fish, and the closer to the head the place is, the higher the value becomes. Thus, in the case of the feature point that can be specified by paying attention to the area of the object at or near the feature point, the attention area is concentrated in the vicinity of the feature point, and the closer to the feature point the position is, the higher the value becomes rapidly.

On the other hand, as shown in FIG. 5B, when the belly of an aquaculture fish is the target feature point of the extraction, the elements of the attention area map Mi which become real values larger than the predetermined value exist in a wide range including the belly of the aquaculture fish, and there is no pronounced high value in the range. Thus, in the case of such a feature point that the feature of the feature point itself is not significant and can be specified by paying attention to the periphery of the feature point over a relatively wide range, the attention area exists over a relatively wide range.

As described above, the learning device 10 learns the parameters of the attention area map output machine so as to output an appropriate attention area map Mi for each type of the feature point, considering that the optimum attention area map Mi differs for each type of feature point. Thereby, the attention area map generation unit 42 can be configured to determine the attention area with an appropriate range for an arbitrary feature point. In this case, the learning device 10 does not need to adjust the parameters for setting the size of the attention area.

### (3-3) Functional Configuration of Second Training

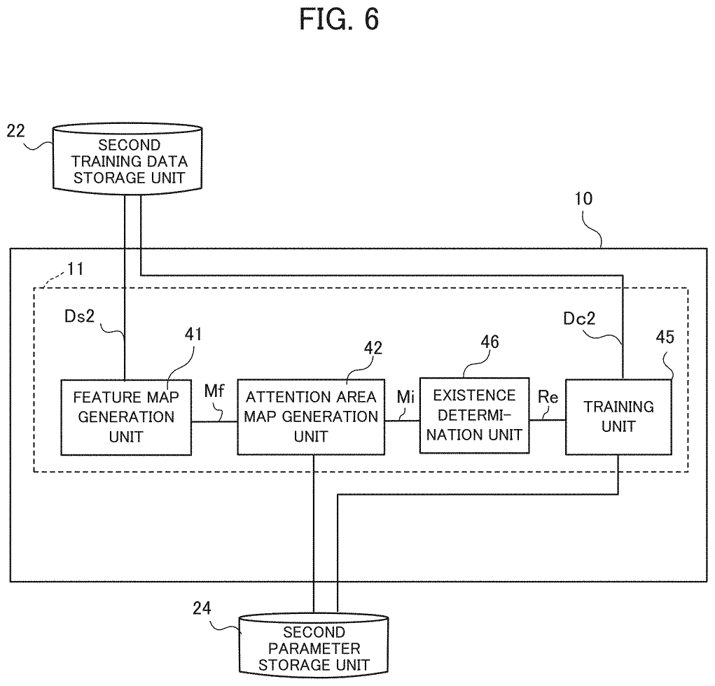

In the second training, the learning device 10 performs the training of the attention area map generation unit 42 based on the information on the existence (presence or absence) of the feature point in the second training image Ds2 to be used for the training. FIG. 6 is a functional block diagram of the learning device 10 according to the second training using the training data stored in the second training data storage section 22. As shown in FIG. 6, the processor 11 of the learning device 10 functionally includes a feature map generation unit 41, an attention area map generation unit 42, a training unit 45, and an existence determination unit 46 in the second training.

In this case, the feature map generation unit 41 acquires the second training image Ds2 from the second training data storage unit 22 and generates the feature map Mf from the acquired second training image Ds2. Then, the feature map generation unit 41 supplies the generated feature map Mf to the attention area map generation unit 42.

The attention area map generation unit 42 converts the feature map Mf, which is generated from the second training image Ds2 by the feature map generation unit 41, into the attention area map Mi. In this case, the attention area map generation unit 42 configures the attention area map output machine by applying the parameters stored in the second parameter storage unit 24 to the learning model configured to output the attention area map Mi from the input feature map Mf. The attention area map generation unit 42 supplies the attention area map Mi obtained by inputting the feature map Mf to the attention area map output machine to the training unit 45.

The existence determination unit 46 determines whether or not the feature point to be extracted exists (i.e., existence), based on the attention area map Mi generated by the attention area map generation unit 42. In this case, for example, on the basis of the GAP (Global Average Pooling), the existence determination unit 46 computes a representative value, such as an average value, a maximum value, a median value, of the values of the elements of the attention area map Mi for each feature point to be extracted and thereby converts the attention area map Mi to a node. Then, the existence determination unit 46 determines whether or not the target feature point exists based on the node, and supplies the existence determination result “Re” to the training unit 45. For example, the parameters referred to by the existence determination unit 46 for outputting the existence determination result Re from the attention area map Mi is stored in the storage device 20. For example, the parameters may include a threshold value for determining the presence or absence of the target feature point from the representative value (node), such as an average value, a maximum value, and a median value, of the values of the elements of the attention area map Mi. In this case, the above-described threshold value is provided for each type of the feature point to be extracted, for example. The above-described parameters may be updated by the training unit 45 in the second training together with the parameters of the attention area map generation unit 42 stored in the second parameter storage unit 24.

The training unit 45 compares the existence determination result Re outputted by the existence determination unit 46 with the second correct answer information Dc2 corresponding to the second training image Ds2 used for the training, and performs correctness determination for the existence determination result Re for each feature point to be extracted. Then, the training unit 45 updates the parameter to be stored in the second parameter storage unit 24 by performing the training of the attention area map generation unit 42 based on the error (loss) specified by the correctness determination. The algorithm for updating the parameters may be any learning algorithm used in machine learning, such as a gradient descent method and an error back-propagation method. Further, in some embodiment, the training unit 45 may perform the training of the existence determination unit 46 together with the training of the attention area map generation unit 42 and update the parameters referred to by the existence determination unit 46. In this case, the training unit 45 performs the training of the attention area map generation unit 42 and the training of the existence determination unit 46 together with the training of the feature point information generation unit 44 in the same manner as the first training. Thereby, the training unit 45 can learn the parameters of the generation model of the attention area map Mi more suitable for improving the extraction accuracy of the feature points.

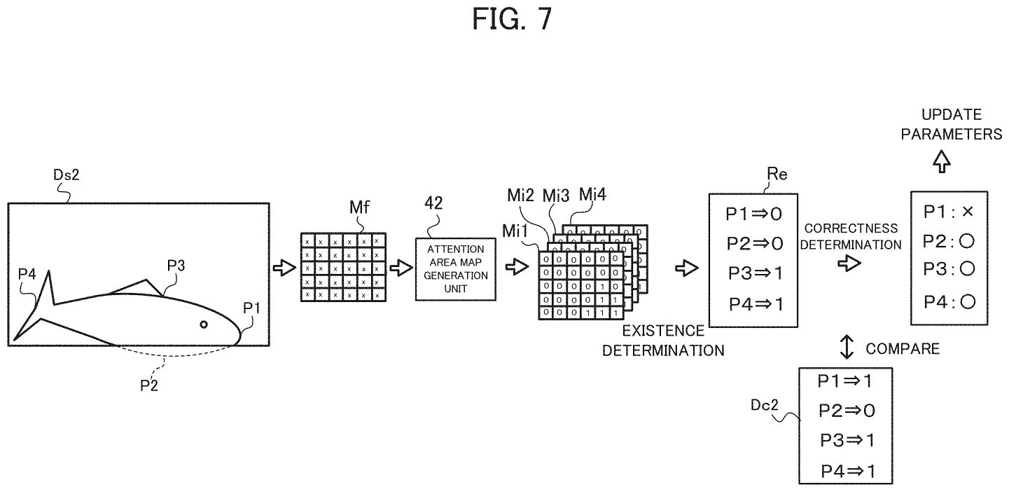

Next, a specific example of the second training will be described with reference to FIG. 7. FIG. 7 is a diagram showing an outline of the second training using the second training image Ds2 displaying aquaculture fish. Here, it is assumed that the head position “P1”, belly position “P2”, back fin position “P3”, and tail fin position “P4” of the aquaculture fish are respectively the target feature points of the extraction.

In FIG. 7, the second training image Ds2 processed from the first training image Ds1 illustrated in FIGS. 5A and 5B is extracted from the second training data storage unit 22 and converted to the feature map Mf by the feature map generation unit 41. In the case where the parameters which are different for each target feature point of extraction are stored in the first parameter storage unit 23, the feature map generation unit 41 may generate the feature map Mf for each of the head position P1, the belly position P2, the back fin position P3, and the tail fin position P4 of the aquaculture fish using different parameters for each target feature point of the extraction. Further, the feature map Mf may be three-dimensional data including the channel direction.

The second training image Ds2 shown in FIG. 7 is an image which is cut out from the first training image Ds1 based on a cutting out position moved by randomly-determined direction and distance from the belly position P2. The second training data storage unit 22 stores a plurality of images which are cut out from the first training image Ds1 on the basis of the belly position P2 in this manner. Further, the second training data storage unit 22 stores a plurality of images which are cut out from the first training image Ds1 on the basis of the head position P1, the back fin position P3, and the tail fin position P4, which are other feature points, respectively. As described above, the second training data storage unit 22 stores a plurality of second training images Ds2 for each feature point, wherein each of the second training images Ds2 is cut out at the cutting position that is a position on the first training image Ds1 randomly defined on the basis of the position of each target feature point of extraction.

Next, the attention area map generation unit 42 converts the feature map Mf generated by the feature map generation unit 41 into the attention area map Mi. In this case, the attention area map generation unit 42 refers to the parameters which are different for each feature point from the second parameter storage unit 24, and generates attention area maps “Mi1” to “Mi4” for the head position P1, the belly position P2, the back fin position P3, and the tail fin position P4.

Then, the existence determination unit 46 determines whether or not each target feature point to be extracted exists in the second training image Ds2, based on the respective attention area maps Mi1 to Mi4 generated by the attention area map generation unit 42. Here, the existence determination unit 46 determines that the head position P1 and the belly position P2 do not exist (“0” in FIG. 7) and the back fin position P3 and the tail fin position P4 exist (“1” in FIG. 7), and supplies the existence determination result Re indicating these determination results to the training unit 45.

The training unit 45 compares the existence determination result Re supplied from the existence determination unit 46 with the second correct answer information Dc2 corresponding to the second training image Ds2, thereby performing a correctness determination for the existence determination result Re. In this case, the training unit 45 determines that the existence determination with respect to the belly position P2, the back fin position P3, and the tail fin position P4 is correct, and that the existence determination with respect to the head position P1 is erroneous. Then, on the basis of the correctness determination result, the training unit 45 updates the parameters of the attention area map generation unit 42 and stores the updated parameters in the second parameter storage unit 24.

As described above, according to the second training, the learning device 10 performs the training of the attention area map generation unit 42 based on the information regarding the presence or absence of the feature point to be extracted. Thereby, the learning device 10 can learn the attention area map generation unit 42 so as to output the attention area map Mi suitable for each feature point to be extracted. It is noted that, since the second training image Ds2 and the second correct answer information Dc2 can be generated from the first training image Ds1 and the first correct answer information Dc1, it is also easy to secure a sufficient number of samples for training the attention area map generation unit 42.

### (3-4) Processing Flow

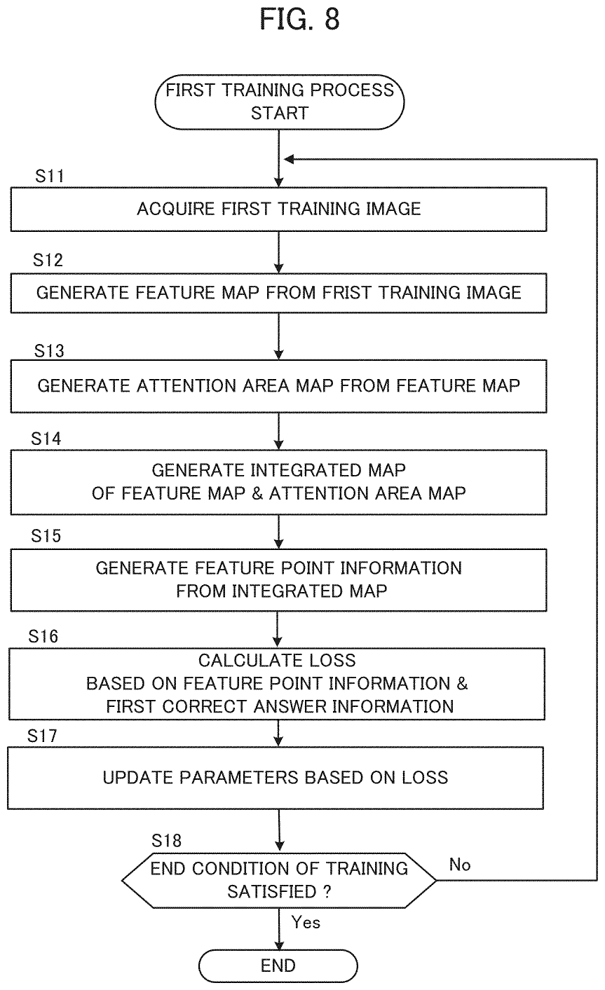

FIG. 8 is a flowchart illustrating a processing procedure of the first training executed by the learning device 10. The learning device 10 executes processing of the flowchart shown in FIG. 8 for each type of the feature point to be detected.

First, the feature map generation unit 41 of the learning device 10 acquires the first training image Ds1 (Step S11). In this case, the feature map generation unit 41 acquires, from first training images Ds1 stored in the first training data storage unit 21, a first training image Ds1 that has not yet been used for training (that is, not previously acquired at Step S11).

Then, the feature map generation unit 41 generates the feature map Mf from the first training image Ds1 acquired at Step S11 by configuring the feature map output machine with reference to the parameters stored in the first parameter storage unit 23 (Step S12). Thereafter, the attention area map generation unit 42 generates the attention area map Mi from the feature map Mf generated by the feature map generation unit 41 by configuring the attention area map output machine with reference to the parameters stored in the second parameter storing unit 24 (Step S13). Then, the map integration unit 43 generates the integrated map Mfi that is the feature map Mf generated by the feature map generation unit 41 integrated with the attention area map Mi generated by the attention area map generation unit 42 (Step S14).

Next, the feature point information generation unit 44 generates the feature point information Ifp from the integrated map Mfi generated by the map integration unit 43 by configuring the feature point information output machine with reference to the parameters stored in the third parameter storing unit 25 (Step S15). Then, the training unit 45 calculates a loss based on the feature point information Ifp generated by the feature point information generation unit 44 and the first correct answer information Dc1 stored in the first training data storage unit 21 in association with the first training image Ds1 (Step S16). Then, the training unit 45 updates the parameters used by the feature map generation unit 41, the attention area map generation unit 42, and the feature point information generation unit 44, respectively, based on the loss calculated at Step S16 (Step S17). In this case, the training unit 45 stores the updated parameters for the feature map generation unit 41 in the first parameter storing unit 23, stores the updated parameters for the attention area map generation unit 42 in the second parameter storing unit 24, and stores the updated parameters for the feature point information generation unit 44 in the third parameter storing unit 25.

Next, the learning device 10 determines whether or not the end condition of training is satisfied (Step S18). The learning device 10 may perform the end determination of the training at Step S18 by, for example, determining whether or not the learning has reached the predetermined number of loops set in advance, or by determining whether or not the training has been executed for a preset number of training data. In another example, the learning device 10 may perform the end determination of the training at Step S18 by determining whether or not the loss has fallen below a preset threshold value, or by determining whether or not the degree of change in the loss has fallen below a preset threshold value. It is noted that the end determination of training at Step S18 may be a combination of the above-described examples, and may be made according to any other determination method.

Then, when the end condition of the training is satisfied (Step S18; Yes), the learning device 10 ends the processing of the flowchart. On the other hand, when the end condition of the training is not satisfied (Step S18; No), the learning device 10 returns the processing to Step S11. In this case, the learning device 10 acquires the first training image Ds1 that is not used at Step S11 from the first training data storage unit 21 and performs the processing at Step S12 and subsequent steps.

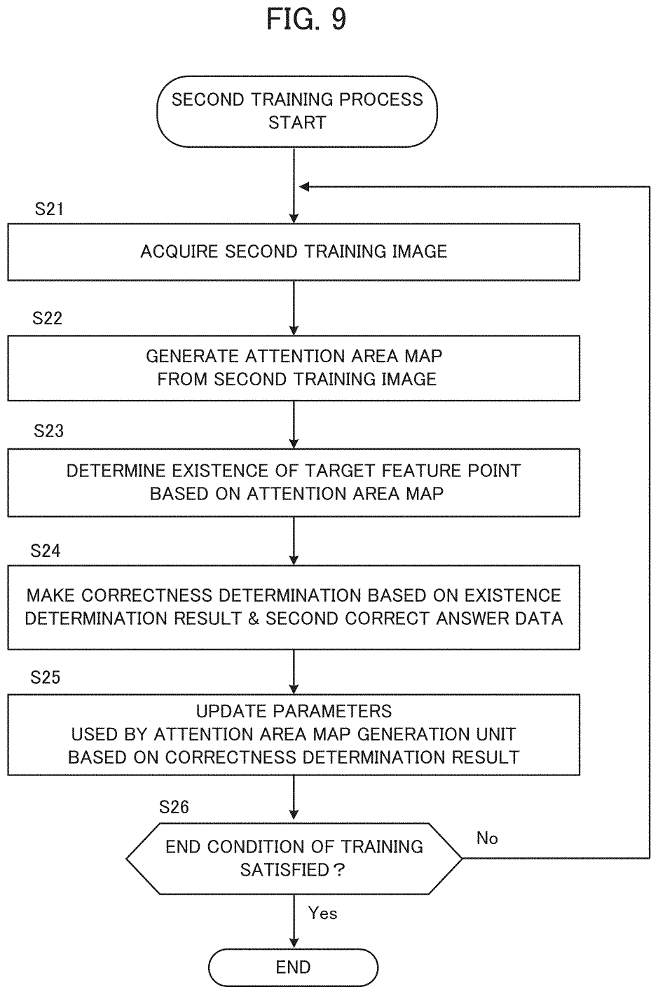

FIG. 9 is a flowchart illustrating a processing procedure of the second training executed by the learning device 10. The learning device 10 executes processing of the flowchart shown in FIG. 9 for each type of feature point to be detected.

First, the feature map generation unit 41 of the learning device 10 acquires a second training image Ds2 (Step S21). In this case, the feature map generation unit 41 acquires, from second training images Ds2 stored in the second training data storage unit 22, a second training image Ds2 that has not yet been used for the second training (that is, not previously acquired at step S21). Then, the feature map generation unit 41 generates the attention area map Mi from the second training image Ds2 acquired at Step S21 (Step S22).

Then, the existence determination unit 46 determines the existence (presence/absence) of the target feature point, based on the attention area map Mi generated at step S22 (Step S23). Then, the training unit 45 performs a correctness determination for the existence determination result Re based on the existence determination result Re generated by the existence determination unit 46 and the second correct answer information Dc2 stored in the second training data storage unit 22 in association with the second training image Ds2 (Step S24). Then, the training unit 45 updates the parameters used by the attention area map generation unit 42 based on the correctness determination result at Step S24 (Step S25). In this case, the training unit 45 determines the parameters used by the attention area map generation unit 42 so as to minimize the loss based on the correctness determination result, and stores the determined parameters in the second parameter storage unit 24. In this case, the training unit 45 may update the parameters used by the existence determination unit 46 together with the parameters used by the attention area map generation unit 42.

Next, the learning device 10 determines whether or not the end condition of the training is satisfied (Step S26). The learning device 10 may perform the end determination of the training at Step S18 by, for example, determining whether or not the training has reached the predetermined number of loops set in advance, or by determining whether or not the training has been executed for a preset number of training data. In addition, the learning device 10 may perform the end determination of the training according to any other arbitrary determination method.

Then, when the end condition of the training is satisfied (Step S26; Yes), the learning device 10 ends the processing of the flowcharts. On the other hand, when the end condition of the training is not satisfied (Step S26; No), the learning device 10 returns the processing to Step S21. In this case, the learning device 10 acquires a second training image Ds2 that is not used at Step S21 from the second training data storage unit 22 and performs the processing at Step S22 and subsequent steps.

### (4) Estimation Process

Next, the estimation process performed by the estimation device 30 will be described below.

### (4-1) Functional Block

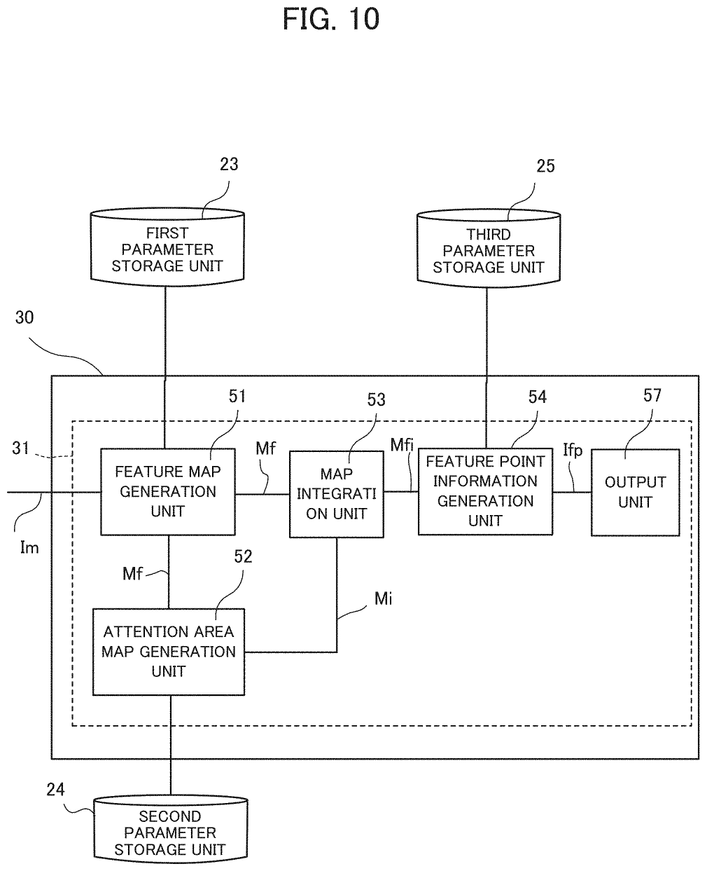

FIG. 10 is a functional block diagram of the estimation device 30. As shown in FIG. 10, the processor 31 of the estimation device 30 functionally includes a feature map generation unit 51, an attention area map generation unit 52, a map integration unit 53, a feature point information generation unit 54, and an output unit 57. The feature map generation unit 51, the attention area map generation unit 52, the map integration unit 53, and the feature point information generation unit 54 have the same functions as the feature map generation unit 41, the attention area map generation unit 42, the map integration unit 43, and the feature point information generation unit 44 of the learning device 10 shown in FIG. 2, respectively.

The feature map generation unit 51 acquires the input image Im from an external device through the interface 13 and converts the acquired input image Im into the feature map Mf. In this case, the feature map generation unit 51 refers to the parameters obtained by the first training from the first parameter storage unit 23 and configures the feature map output machine based on the parameters. The feature map generation unit 51 supplies the feature map Mf obtained by inputting the input image Im to the feature map output machine to the attention area map generation unit 52 and the map integration unit 53, respectively.

The attention area map generation unit 52 converts the feature map Mf supplied from the feature map generation unit 51 into the attention area map Mi. In this case, the attention area map generation unit 52 refers to the parameters stored in the second parameter storage unit 24 and configures the attention area map output machine based on the parameters. The attention area map generation unit 52 supplies the attention area map Mi obtained by inputting the feature map Mf to the attention area map output machine to the map integration unit 53.

The map integration unit 53 generates the integrated map Mfi by integrating the feature map Mf supplied from the feature map generation unit 51 and the attention area map Mi to which the attention area map generation unit 52 converted from the feature map Mf.

The feature point information generation unit 54 generates feature point information Ifp, based on the integrated map Mfi supplied from the map integration unit 53. In this case, by referring to the parameters stored in the third parameter storage unit 25, the attention area map generation unit 52 configures a feature point information output machine. The feature point information generation unit 54 supplies the feature point information Ifp obtained by inputting the integrated map Mfi to the feature point information output machine to the output unit 57.

On the basis of the feature point information Ifp, the output unit 57 outputs the identification information of the target feature point of extraction and the information indicating the position of the target feature point (for example, the pixel position on the first training image Ds1) to an external device or a processing block in the estimation device 30. The external device or the processing block in the estimation device 30 described above can apply the information received from the output unit 57 to various applications. This application will be described in “(5) Application Examples”.

Here, a description will be given of a method for calculating the position of the feature point to be outputted by the output unit 57 when the feature point information Ifp indicates the reliability map for each target feature point of extraction. In this case, for example, the output unit 57 outputs, as the position of the feature point, the position whose degree of the reliability is the maximum and equal to or larger than a predetermined threshold value. In another example, the output unit 57 calculates the position of the center of gravity of the reliability map as the position of the feature point. In yet another example, the output unit 57 outputs a position where the continuous function (regression curve) approximating the reliability map that is discrete data is maximized, as the position of the feature point. In yet another example, in consideration of the case where there are plural points corresponding to the target feature point, the output unit 57 outputs, as the position of the feature point, one or more positions in the input image Im in which the reliability is a local maximum and is equal to or larger than a predetermined threshold value. When the feature point information Ifp indicates the coordinate value of the feature point in the input image Im, the output unit 57 may output the coordinate value as it is as the position of the feature point.

### (4-2) Processing Flow

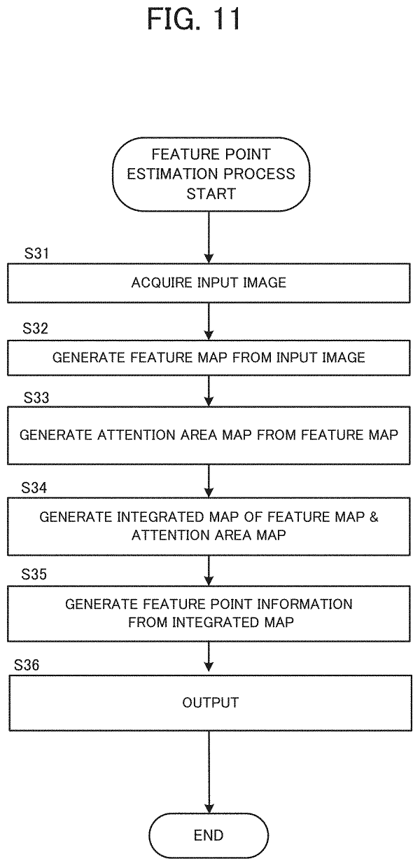

FIG. 11 is a flowchart showing the procedure of the estimation process performed by the estimation device 30. The estimation device 30 repeatedly executes the processing of the flowchart shown in FIG. 11 every time an input image Im is inputted to the estimation device 30.

First, the feature map generation unit 51 of the estimation device 30 acquires an input image Im supplied from an external device (Step S31). Then, the feature map generation unit 51 generates the feature map Mf from the input image Im acquired at Step S31 by configuring the feature map output machine with reference to the parameters stored in the first parameter storing unit 23 (Step S32). Thereafter, by configuring the attention area map output machine with reference to the parameters stored in the second parameter storing unit 24, the attention area map generation unit 52 generates the attention area map Mi from the feature map Mf generated by the feature map generation unit 51 (Step S33). The map integration unit 53 generates an integrated map Mfi of the feature map Mf generated by the feature map generation unit 51 and the attention area map Mi generated by the attention area map generation unit 52 (Step S34).

Next, by configuring the feature point information output machine with reference to the parameters stored in the third parameter storing unit 25, the feature point information generation unit 54 generates the feature point information Ifp from the integrated map Mfi generated by the map integration unit 53 (Step S35). Then, the output unit 57 outputs the information indicating the position of the feature point specified from the feature point information Ifp generated by the feature point information generation unit 54 and the identification information of the feature point to an external device or another processing block in the estimation device 30 (step S36).

### (5) Application Examples

Next, application examples of the estimation processing result of the feature point by the estimation device 30.

The first application example is related to the automatic measurement of an aquaculture fish. In this case, the estimation device 30 estimates the head position, belly position, back fin position, and tail fin position of the aquaculture fish with a high degree of accuracy based on the input image Im representing the aquaculture fish as shown in FIGS. 5A and 5B. Then, the estimation device 30 or the external device for receiving the information regarding the feature point from the estimation device 30 can suitably perform, on the basis of the information, automatic measurement of the aquaculture fish displayed on the input image Im and the like.

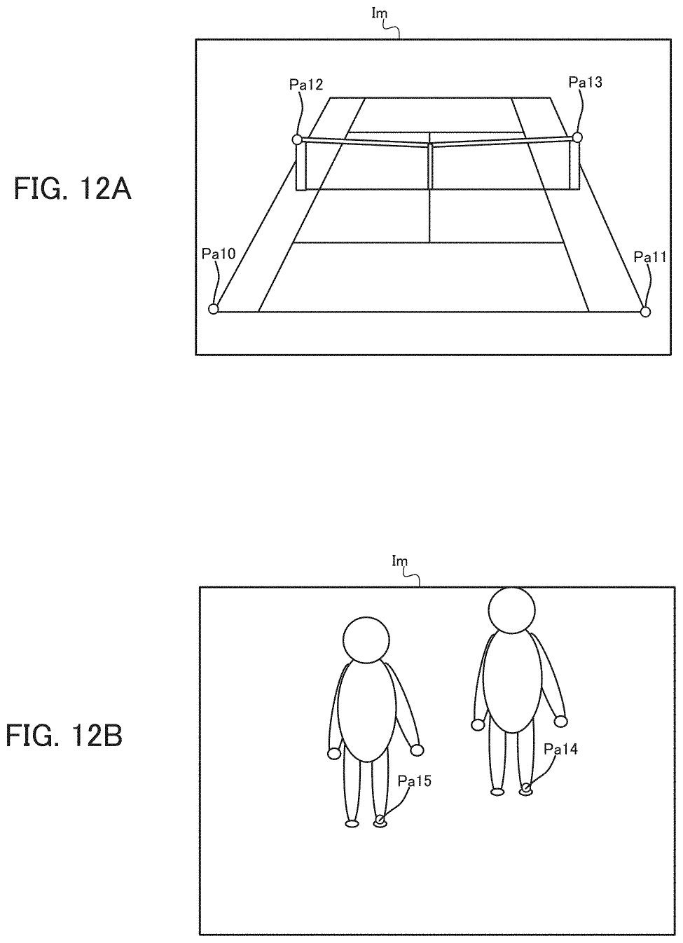

The second application example concerns AR (Augmented Reality) in sporting viewing. FIG. 12A is a diagram illustrating an estimate positions Pa10 to Pa13 of feature points calculated by the estimation device 30 on an input image Im obtained by photographing a tennis coat.

In this example, the learning device 10 performs learning for extracting each of feature points corresponding to the left corner, the right corner, the vertex of the left pole, and the vertex of the right pole of the front half of the tennis coat. Then, the estimation device 30 estimates the positions of the feature points (corresponding to the estimated positions Pa10 to Pa13) with a high degree of accuracy.

By extracting feature points using an image taken during such sports viewing as an input image Im, it is possible to suitably perform calibration of AR (Augmented Reality) in sports viewing. For example, when a head-mounted display or the like incorporating the estimation device 30 superimposes an AR image on the real world, the estimation device 30 estimates the positions of predetermined feature points serving as a reference in the target sport based on the input image Im captured by the head-mounted display from the vicinity of the user's viewpoint. This makes it possible for the head-mounted display to accurately perform the calibration of the AR and to display images accurately associated with the real world.

The third application example concerns a security application. FIG. 12B is a diagram illustrating an estimate positions Pa14 and Pa15 corresponding to feature points estimated by the estimation device 30 on the input image Im obtained by photographing a person.

In this example, the learning device 10 executes learning for extracting a human ankle (here, the left ankle) as a feature point, and the estimation device 30 estimates the positions (corresponding to the estimate positions Pa14 and Pa15) corresponding to the feature point in the input image Im. In the example of FIG. 12B, since there are people, for example, the estimation device 30 divides the input image Im into a plurality of areas and performs the estimation processing on each of the areas after the division as the input image Im, respectively. In this case, the estimation device 30 may divide the input image Im by a predetermined size, or may divide the input image Im for each person detected by a known person detection algorithm.

By performing feature point extraction in this way using an image obtained by photographing a person as an input image Im, it is possible to apply it to the security field. For example, the estimation device 30 can accurately capture the position of a person by using the position information of the ankle extracted with a high degree of accuracy (corresponding to the estimate positions Pa14 and Pa15), and suitably perform, for example, the entry detection of a person to a predetermined area determined in advance.

### (6) Modification

Next, a description will be given of preferred modifications to the example embodiment described above. Modifications described below may be applied to the example embodiment described above in arbitrary combination.

### First Modification

The configuration of the information processing system 100 shown in FIG. 1 is an example, and the configuration to which the present invention can be applied is not limited thereto.

For example, the learning device 10 and the estimation device 30 may be configured by the same device. In another example, the information processing system 100 may not have a storage device 20. In the latter example, for example, the learning device 10 includes the first training data storage unit 21 and the second training data storage unit 22 in the memory 12. Further, after execution of the learning, the learning device 10 transmits parameters to be stored in the first parameter storage unit 23, the second parameter storage unit 24, and the third parameter storage unit 25 to the estimation device 30. Then, the estimation device 30 stores the received parameters in the memory 32.

### Second Modification

In the first training, the learning device 10 may not perform the learning of the feature map generation unit 41 and only perform the learning of the attention area map generation unit 42 and the feature point information generation unit 44.

In this case, for example, before the learning of the attention area map generation unit 42 and the feature point information generation unit 44, the parameters to be used by the feature map generation unit 41 are determined in advance and are stored in the first parameter storing unit 23. Then, in the first training, the training unit 45 of the learning device 10 determines the parameters of the attention area map generation unit 42 and the feature point information generation unit 44 so that the loss based on the feature point information Ifp and the first correct answer information Dc1 is minimized. Even in this mode, by simultaneously performing the training of the attention area map generation unit 42 with the training the feature point information generation unit 44, the training unit 45 can suitably learn the attention area map generation unit 42 so as to output the attention area map Mi such that the extraction accuracy of the feature point is improved.

### Second Example Embodiment

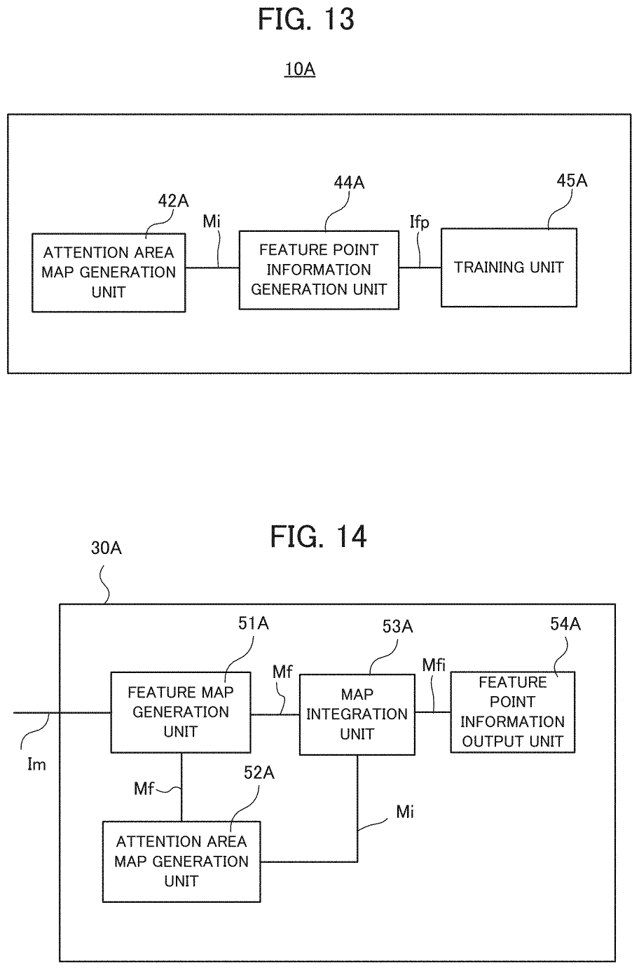

FIG. 13 is a block configuration diagram of a learning device 10A according to a second example embodiment. As shown in FIG. 13, the learning device 10A includes an attention area map generation unit 42A, a feature point information generation unit 44A, and a training unit 45A.

The attention area map generation unit 42A is configured to generate an attention area map Mi, which is a map representing a degree of importance in the position estimation of a feature point subjected to extraction, from a feature map Mf that is a map of the feature quantities relating to the feature point, the feature map Mf being generated based on an input image. The attention area map generation unit 42A may generate the feature map Mf based on the input image or acquire it from an external device. In the former case, the attention area map generation unit 42A corresponds to, for example, the feature map generation unit 41 and the attention area map generation unit 42 according to the first example embodiment. In the latter case, for example, the feature map Mf may be generated by the external device executing the process in place of the feature map generation unit 41.

The feature point information generation unit 44A is configured to generate feature point information Ifp, which is information relating to an estimate position of the feature point, based on an integrated map Mfi in which the feature point map Mf and the attention area map Mi are integrated. The feature point information generation unit 44A corresponds to, for example, the map integration unit 43 and the feature point information generation unit 44 according to the first example embodiment.

The training unit 45A is configured to perform training of the attention area map generation unit 42A and the feature point information generation unit 44A based on the feature point information Ifp and correct answer information regarding a correct answer position of the feature point.

According to this configuration, the learning device 10A can suitably learn the attention area map generation unit 42A so as to output the attention area map Mi which appropriately specifies the area to be paid attention to in the position estimation of the feature point. Further, by training the attention area map generation unit 42A together with the feature point information generation unit 44A, the learning device 10A can suitably learn the attention area map generation unit 42A so as to output the attention area map Mi such that the extraction accuracy of the feature point is improved.

FIG. 14 is a block diagram of the estimation device 30A according to the second example embodiment. As shown in FIG. 14, the estimation device 30A includes a feature map generation unit 51A, an attention area map generation unit 52A, a map integration unit 53A, and a feature point information generation unit 54A.

The feature map generation unit 51A is configured to generate a feature map Mf, which is a map of feature quantities relating to a feature point subjected to extraction, from an input image. The attention area map generation unit 52A is configured to generate an attention area map Mi, which is a map representing a degree of importance in the position estimation of the feature point, from the feature map Mf. The map integration unit 53A is configured to generate an integrated map Mfi in which the feature map Mf and the attention area map Mi are integrated. The feature point information generation unit 54A is configured to generate feature point information Ifp, which is information relating to an estimate position of the feature point, based on the integrated map Mfi.

According to this configuration, the estimation device 30A can appropriately determine the area to be paid attention to in the position estimation of the feature point and suitably perform the position estimation of the feature point.

The whole or a part of the example embodiments described above (including modifications, the same applies hereinafter) can be described as, but not limited to, the following Supplementary Notes.

### Supplementary Note 1

An estimation device comprising:

a feature map generation unit configured to generate a feature map, which is a map of feature quantities relating to a feature point subjected to extraction, from an input image;

an attention area map generation unit configured to generate an attention area map, which is a map representing a degree of importance in position estimation of the feature point, from the feature map;

a map integration unit configured to generate an integrated map in which the feature map and the attention area map are integrated; and

a feature point information generation unit configured to generate feature point information, which is information relating to an estimate position of the feature point, based on the integrated map.

### Supplementary Note 2

The estimation device according to Supplementary Note 1,

wherein the attention area map generation unit is configured to generate, as the attention area map, a map representing the degree of importance by a binary number or a real number for each element of the feature map.

### Supplementary Note 3

The estimation device according to Supplementary Note 1 or 2,

wherein the attention area map generation unit is configured to generate, as the attention area map, a map in which a positive constant is added to a binary number 0 or 1 or a real number from 0 to 1 indicative of the degree of importance for each element of the feature map.

### Supplementary Note 4

The estimation device according to any one of Supplementary Notes 1 to 3,

wherein the map integration unit is configured to generate, as the integrated map, a map in which the attention area map is multiplied by or added to the feature map on element-by-element basis or the attention area map is coupled to the feature map in a channel direction.

### Supplementary Note 5

A learning device comprising:

an attention area map generation unit configured to generate an attention area map, which is a map representing a degree of importance in position estimation of a feature point subjected to extraction, from a feature map that is a map of feature quantities relating to the feature point, the feature map being generated based on an input image;

a feature point information generation unit configured to generate feature point information, which is information relating to an estimate position of the feature point, based on an integrated map in which the feature point map and the attention area map are integrated; and

a training unit configured to perform training of the attention area map generation unit and the feature point information generation unit based on the feature point information and correct answer information regarding a correct answer position of the feature point.

### Supplementary Note 6

The learning device according to Supplementary Note 5, further comprising

a feature map generation unit configured to generate the feature map from the input image,

wherein the training unit is configured to perform training of the feature map generation unit, the attention area map generation unit and the feature point information generation unit based on the feature point information and the correct answer information.

### Supplementary Note 7

The learning device according to Supplementary Note 6,

wherein the training unit is configured to updates parameters to be applied to the feature map generation unit, the attention area map generation unit, and the feature point information generation unit, respectively, based on a loss calculated from the feature point information and the correct answer information.

### Supplementary Note 8

The learning device according to any one of Supplementary Notes 5 to 7,

wherein the training unit is configured to perform
a first training that is the training based on the feature point information and the correct answer information,
a second training that is the training of the attention area map generation unit based on
   a determination result of existence of the feature point in a second input image based on the attention area map and
   second correct answer information regarding the existence of the feature point in the second input image.

### Supplementary Note 9

The learning device according to Supplementary Note 8,

wherein the training unit is configured to determine the existence of the feature point in the second input image based on a representative value of each element of the attention area map.

### Supplementary Note 10

The learning device according to Supplementary Note 8 or 9,

wherein the learning unit is configured to use, as the second input image for the second training, an image that is the image used in the first training and processed based on the position of the feature point.

### Supplementary Note 11

The learning device according to any one of Supplementary Notes 5 to 10, further comprising

a map integration unit configured to generate an integrated map in which the feature map and the attention area map are integrated,

wherein the feature point information generation unit is configured to generate the feature point information based on the integrated map generated by the map integration unit.

### Supplementary Note 12

A control method performed by an estimation device, the control method comprising:

generating a feature map, which is a map of feature quantities relating to a feature point subjected to extraction, from an input image;

generating an attention area map, which is a map representing a degree of importance in position estimation of the feature point, from the feature map;

generating an integrated map in which the feature map and the attention area map are integrated; and

generating feature point information, which is information relating to an estimate position of the feature point, based on the integrated map.

### Supplementary Note 13

A control method performed by a learning device, the control method comprising:

generating an attention area map, which is a map representing a degree of importance in position estimation of a feature point subjected to extraction, from a feature map that is a map of feature quantities relating to the feature point, the feature map being generated based on an input image;

generating feature point information, which is information relating to an estimate position of the feature point, based on an integrated map in which the feature point map and the attention area map are integrated; and

performing training of a process of generating the attention area map and a process of generating the feature point information, based on the feature point information and correct answer information regarding a correct answer position of the feature point.

### Supplementary Note 14

A storage medium storing a program executed by a computer, the program causing the computer to function as:

a feature map generation unit configured to generate a feature map, which is a map of feature quantities relating to a feature point subjected to extraction, from an input image;

an attention area map generation unit configured to generate an attention area map, which is a map representing a degree of importance in position estimation of the feature point, from the feature map;

a map integration unit configured to generate an integrated map in which the feature map and the attention area map are integrated; and

a feature point information generation unit configured to generate feature point information, which is information relating to an estimate position of the feature point, based on the integrated map.

### Supplementary Note 15

A storage medium storing a program executed by a computer, the program causing the computer to function as:

an attention area map generation unit configured to generate an attention area map, which is a map representing a degree of importance in position estimation of a feature point subjected to extraction, from a feature map that is a map of feature quantities relating to the feature point, the feature map being generated based on an input image;

a feature point information generation unit configured to generate feature point information, which is information relating to an estimate position of the feature point, based on an integrated map in which the feature point map and the attention area map are integrated; and

a training unit configured to perform training of the attention area map generation unit and the feature point information generation unit based on the feature point information and correct answer information regarding a correct answer position of the feature point.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

10 Learning device

11, 31 Processor

12, 32 Memory

13, 33 Interface

20 Storage device

21 First training data storage unit

22 Second training data storage unit

23 First parameter storage unit

24 Second parameter storage unit

25 Third parameter storage unit

30 Estimation device

100 Information processing system

What is claimed is:

1. An estimation device comprising:
at least one memory configured to store instructions; and
at least one processor configured to execute the instructions to
generate a feature map, which is a map of feature quantities relating to a feature point subjected to extraction, from an input image;
generate an attention area map, which is a map representing a degree of importance in position estimation of the feature point, from the feature map;
generate an integrated map in which the feature map and the attention area map are integrated; and
generate feature point information, which is information relating to an estimate position of the feature point, based on the integrated map.

2. The estimation device according to claim 1,
wherein the at least one processor is configured to generate, as the attention area map, a map representing the degree of importance by a binary number or a real number for each element of the feature map.

3. The estimation device according to claim 1,
wherein the at least one processor is configured to generate, as the attention area map, a map in which a positive constant is added to a binary number 0 or 1 or a real number from 0 to 1 indicative of the degree of importance for each element of the feature map.

4. The estimation device according to claim 1,
wherein at least one processor is configured to generate, as the integrated map, a map in which the attention area map is multiplied by or added to the feature map on element-by-element basis or the attention area map is coupled to the feature map in a channel direction.

5. A learning device comprising:
at least one memory configured to store instructions; and
at least one processor configured to execute the instructions to function as:
an attention area map generation unit configured to generate an attention area map, which is a map representing a degree of importance in position estimation of a feature point subjected to extraction, from a feature map that is a map of feature quantities relating to the feature point, the feature map being generated based on an input image;
a feature point information generation unit configured to generate feature point information, which is information relating to an estimate position of the feature point, based on an integrated map in which the feature point map and the attention area map are integrated; and
a training unit configured to perform training of the attention area map generation unit and the feature point information generation unit based on the feature point information and correct answer information regarding a correct answer position of the feature point.

6. The learning device according to claim 5,
wherein the at least one processor is configured to further function as
a feature map generation unit configured to generate the feature map from the input image,
wherein the training unit is configured to perform training of the feature map generation unit, the attention area map generation unit and the feature point information generation unit based on the feature point information and the correct answer information.

7. The learning device according to claim 6,
wherein the training unit is configured to update parameters to be applied to the feature map generation unit, the attention area map generation unit, and the feature point information generation unit, respectively, based on a loss calculated from the feature point information and the correct answer information.

8. The learning device according to claim 5,
wherein the training unit is configured to perform
a first training that is the training based on the feature point information and the correct answer information,
a second training that is the training of the attention area map generation unit based on
a determination result of existence of the feature point in a second input image based on the attention area map and
second correct answer information regarding the existence of the feature point in the second input image.

9. The learning device according to claim 8,
wherein the training unit is configured to determine the existence of the feature point in the second input image based on a representative value of each element of the attention area map.

10. The learning device according to claim 8,
wherein the learning unit is configured to use, as the second input image for the second training, an image that is the image used in the first training and processed based on the position of the feature point.

11. The learning device according to claim 5,
wherein the at least one processor is configured to further function as
a map integration unit configured to generate an integrated map in which the feature map and the attention area map are integrated,
wherein the feature point information generation unit is configured to generate the feature point information based on the integrated map generated by the map integration unit.

12. A control method performed by an estimation device, the control method comprising:
generating a feature map, which is a map of feature quantities relating to a feature point subjected to extraction, from an input image;
generating an attention area map, which is a map representing a degree of importance in position estimation of the feature point, from the feature map;
generating an integrated map in which the feature map and the attention area map are integrated; and
generating feature point information, which is information relating to an estimate position of the feature point, based on the integrated map.

13-15. (canceled)
